(19) United States
(12) Patent Application Publication
(10) Pub. No.: US 2023/0379721 A1
(43) Pub. Date: Nov. 23, 2023

(54) SYSTEMS AND METHODS FOR SHARING PRIVATE NETWORK VIA MIDHAUL-GW INTERFACE TO FACILITATE MOBILE NETWORK OPERATOR ACCESS

(71) Applicant: The MITRE Corporation, McLean, VA (US)

(72) Inventor: Praveen GUPTA, McLean, VA (US)

(73) Assignee: The MITRE Corporation, McLean, VA (US)

(21) Appl. No.: 17/746,605

(22) Filed: May 17, 2022

(51) Int. Cl. H04W 16/14; H04W 72/12; H04W 72/04

(52) U.S. Cl. CPC H04W 16/14; H04W 72/1263; H04W 72/0453; H04W 92/24

(57) ABSTRACT

Described herein are systems and methods for implementing a hybrid 5G-RAN solution using one or more F1-GWs or IAB-GWs connecting to a F1-PP or IAB-PP of a Private 5G-RAN that can be configured to allow one or more mobile network operators and/or private network operators access to a shared radio access network. In one or more examples, the Private 5G-RAN can be shared via secure F1 or IAB protection-proxy connection to a MNO's F1 or IAB gateway at the mid-haul level of a 5G wireless network. In one or more examples, the F1 or IAB protection-proxy can be configured to receive network traffic from MNO's CU or IAB donor nodes associated with mobile network operator (MNO). The IAB protection-proxy can receive the traffic from the one or more MNO's IAB-gateway nodes, and can transmit the traffic to one or more distributed units based on the intended recipient of the traffic.

### FIELD

This disclosure relates systems and methods for implementing hybrid 5G network by sharing private 5G network via Midhaul-GW, that allows user access to both a private 5G network as well as one or more mobile network operator (MNO) public networks.

### BACKGROUND

The use of mobile phones and mobile computing devices has become the prevalent means of communications in modern society. Mobile devices allow users to have access to both voice communications and data (i.e., through the internet) without requiring them to be tethered to a wired connection. Thus, a user can access voice communications and data anywhere where they can carry their device. In order to provide a user with a robust mobile device experience, a mobile network operator (“MNO”) provides a “network” to the user so as to ensure that the user has access to their network no matter their location. The quality of a mobile network operator's network is only as good as the “coverage area” (i.e., the geographic area where the user has access to the network) that the MNO can provide. Thus, MNO's want to ensure that their users have cell phone coverage everywhere that they may be.

Providing mobile network coverage inside a facility or building can present a challenge. Often times, MNOs communicate with their user's mobile devices using a network of cell towers that transmit and receive signals to and from their user's devices. However, in large buildings and/or facilities, the signal quality inside the facility may be degraded due to the structure of the facility interfering with the MNO's radio signals. Thus, once a user of a MNO goes into a facility, they may lose the ability to use their mobile device. Providing cell phone coverage inside a large facility can be cost prohibitive. In order to provide coverage an MNO may be required to place their own equipment inside of the facility to provide the signal strength necessary to provide coverage. Furthermore, since the occupants of a facility don't all use the same MNO (each MNO represents a separate mobile service provider) each MNO would have to separately place their equipment in the facility. The cost to outfit separate equipment by each MNO inside a facility can be expensive and thus neither the individual MNO's nor the enterprise associated with the facility may be willing to incur the costs required to place each MNOs equipment in their facility to ensure their occupants get access to their preferred mobile network.

Often times enterprises that own and operate a facility may also have their own 5G private network so that the mobile devices owned and operated by the facility can have access to voice and data communications that are privately maintained by the employees/device associated only with the enterprise. Thus, in the event that a facility wants to support both a private 5G network and one or more public MNO network accesses within their facility, the facility may need to operate multiple separate network equipment to operate both the public MNO access and the private 5G wireless access. The large amount of equipment to support both private 5G network operations as well as multiple MNO operations may be both logistically and cost prohibitive. A single system that can support both private 5G operations as well as facilitate network access to multiple MNO's can reduce the cost and complexity by providing a single network that can facilitate all of the needed network access (both public and private).

### SUMMARY

Described herein are systems and methods for utilizing a private 5G radio access network to support public-network MNO network traffic. In one or more examples, a private 5G-RAN network can be defined as a network of a Private distributed units (DUs) and Radio units (RUs) providing access to 5G devices and users. In one or more examples, a public 5G Network can be defined as a 5G network owned and managed by Mobile network operator (MNO). In one or more examples, the systems and methods described herein can utilize Midhaul technology such as modified F1-interface or integrated access backhaul (“IAB”) technology to provide hybrid—public and private—network access while maintaining both the private network and public networks security requirements/concerns. In one or more examples, the systems and methods can include a F1-protection proxy (F1-PP) or IAB-protection-proxy (IAB-PP) that can be configured to support public MNO traffic on a private 5G network. In one or more examples, the F1-PP or IAB-PP can be implemented as a MNO's DU with IAB or F1 protection-proxy in a private 5G-RAN network. In one or more examples, an MNO can support connection to many F1-PP via MNO's F1-gateway for support of MNO-traffic on Private 5G network and protection of MNO's RAN network. In one or more examples, for private 5G-RAN sharing via IAB, MNO's IAB-gateway can be used, which connects to MNO-network as an IAB-relay or IAB-DU gateway to support protection and mobility of traffic from MNO-network to Private 5G-network. In one or more examples, the F1-PP+DU and/or IAB-PP+DU can be connected to one or more private 5G-RAN radio units (“RU”) that can be connected to one or more users in the network.

In one or more examples, the F1-PP or IAB-PP can be configured to support MNO traffic on private 5G-RAN using one or more physical resource blocks (“PRBs) of Private 5G-RAN network. In one or more examples, the traffic from a private network and the MNOs can be assigned to one or more PRBs. Private 5G-RAN network will support Private 5G-user traffic as well as multiple MNO user traffic to create Multi-Operator Radio Access Network (“MORAN”) or Multi-Operator Core Network (“MOCN”) network.

In one or more examples, a Radio Access Network (RAN) system configured to provided shared access to a plurality of mobile network operators (MNOs), the system comprises: one or more donor distributed units, wherein each donor distributed unit is associated with its own mobile network operator, wherein each donor distributed unit is configured to transmit data to and receive data from a centralized unit of the mobile network operator associated with the distributed unit, one or more radio units configured to communicate with one or more end user computing devices, and a scheduler distributed unit, wherein the scheduler distributed is communicatively coupled to each of the one or more donor distributed units, wherein the scheduler distributed unit is configured to receive traffic from one or more donor distributed units and transmit the data to the one or more radio units for transmission to the one or more end user computing devices, and wherein the scheduler distributed unit is configured to receive data from the one or more radio units and transmit the received data to a donor distributed unit of the one or more distributed unites based on a MNO associated with the data received from the one or more radio units.

Optionally, the scheduler distributed unit is configured to control a frequency band at which the one or more radio units are configured to wirelessly communicate with the one or more end user devices; and wherein the distributed units control the frequency band at which the one or more radio units are configured to control the frequency band by transmitting one or more physical resource blocks of a plurality of physical resource blocks to the radio units.

Optionally, the scheduler distributed unit selects the physical resource block to the send to the radio units based on a determined identity of the MNO associated with the donor DU from which data is received from.

Optionally, the donor distributed units are configured to handle data transmissions at the Medium Access Control (MAC) layer of a 5G wireless protocol.

Optionally, the scheduler distributed unit is configured to: receive a plurality data transmissions from the one or more distributed units, determine the identity of the mobile network operator associated with each received data transmission of the plurality of data transmissions, determine an intended recipient end user device for each received data transmission of the plurality of received data transmissions, wherein determining an intended recipient end user device for each received data transmission is based on the received data transmission, determine which radio units of the one or more radio units are associated with the intended recipient end user device, and transmit the data to the determined radio unit.

Optionally, transmit the data to the determined radio unit comprises assigning or more physical resource blocks of a plurality of physical resource blocks to the radio units based on the MNO associated with the received traffic.

Optionally, the scheduler distributed unit is configured to perform High-PHY layer processing.

Optionally, the scheduler distributed unit is configured to: receive data from the one or more radio units, determine an MNO associated with the received data, and transmit the received data to the donor distributed unit associated with the determined MNO associated with the received data.

Optionally, the scheduler DU is configured to perform upper-PHY layer processing on the received data.

Optionally, the scheduler DU is configured to combine the received data from the one or more radio units into a PHY layer frame.

Optionally, the scheduler DU is configured to perform low MAC processing on the PHY frame.

Optionally, the distributed unit associated with the determined MNO is configured to perform high medium access control (MAC) processing.

Optionally, the distributed unit associated with the determined MNO is configured to perform radio link control (RLC) processing.

Optionally, the one or more donor distributed units are implemented as Integrated Access Backhaul Protection Proxy (IAB-PP) distributed units.

Optionally, the IAB-PP distributed unit is communicatively coupled to a donor centralized unit associated with its MNO using a wireless connection.

Optionally, the IAB-PP is configured to wirelessly communicate with an IAB gateway device that is connected to the donor centralized unit associated with its MNO.

Optionally, the IAB gateway device is configured to determine whether the data from the IAB-PP is safe for transmission to the donor centralized unit.

Optionally, the one or more donor distributed units are implemented as F1 Protection Proxy (FI-PP) distributed units.

Optionally, the F1-PP distributed unit is communicatively coupled to a donor centralized unit associated with its MNO using a wired connection.

Optionally, the F1-PP is configured to communicate with a F1 gateway device that is connected to the donor centralized unit associated with its MNO.

Optionally, the F1 gateway device is configured to determine whether the data from the F1-PP is safe for transmission to the donor centralized unit.

### BRIEF DESCRIPTION OF THE FIGURES

The invention will now be described, by way of example only, with reference to the accompanying drawings, in which:

FIG. 1 illustrates a private RAN architecture according to examples of the disclosure.

FIG. 2A illustrates an exemplary spectrum sharing system according to examples of the disclosure.

FIG. 2B illustrates another exemplary spectrum sharing system according to examples of the disclosure.

FIG. 3 illustrates an exemplary Hybrid 5G system according to examples of the disclosure.

FIG. 4 illustrates an exemplary Private 5G RAN sharing and slicing system for private and public network traffic according to examples of the disclosure.

FIG. 5 illustrates an exemplary process for routing network traffic from a public/private network to one or more end users according to examples of the disclosure.

FIG. 6 illustrates an exemplary process for routing network traffic from one or more end users to one or more public and/or private networks according to examples of the disclosure.

FIG. 7 illustrates an exemplary computing system, according to examples of the disclosure.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Described herein are systems and methods for implementing a hybrid 5G-RAN solution using one or more F1-GWs or IAB-GWs of one or more Public 5G-RAN CUs connecting to F1-PP or IAB-PP of Private 5G-RAN that can be configured to allow one or more mobile network operators and/or private network operators access to a shared radio access network. In one or more examples, the Private 5G-RAN can be shared via secure F1 or IAB protection-proxy connection to MVO's F1 or IAB gateway at the mid-haul level of a 5G wireless network. In one or more examples, the F1 or IAB protection-proxy can be configured to receive network traffic from MNO's CU or IAB donor nodes associated with mobile network operator (MNO). In one or more examples, the IAB protection-proxy can receive the traffic from the one or more MNO's IAB-gateway nodes, and can transmit the traffic to one or more distributed units based on the intended recipient of the traffic. Additionally, or alternatively, the systems and methods can connect Private 5G-RAN F1-protection-proxy via MNO's wired connection to F1-GW of MNO public 5G network. In one or more examples, the F1 protection-proxy and/or IAB protection-proxy can be connected to one or more distributed units, with each distributed unit connected to one or more radio units. In one or more examples, the one or more radio units can serve as wireless access points for one or more end user devices. Private 5G-RAN is shared using dedicated RAN-slice for each MNO traffic to ensure secure and traffic isolation.

The systems and methods described herein thus not only allow for a shared RAN architecture that can take advantage of cell virtualization in the front-haul of the system, but also allows for multiple mobile network operators to share the RAN while avoiding security issues that may occur when one mobile network operator is required to depend on another mobile network operator's equipment to have access to the RAN.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present disclosure as described herein.

Radio access networks (“RAN”) are configured to provide a mobile user and/or a mobile computing device with wireless access to the core network of MNO or other network provider. In one or more examples, a RAN can receive radio transmissions from a user, and then transmit the received transmissions to a core network where they are processed. For instance, in the case of voice data (i.e., cell phone conversations), a user's speech is transmitted wirelessly to a RAN (often operated by their mobile service provider) which then transmits the message to a core network, which processes the message by routing it to the intended recipient of the voice transmission. Likewise, data transmissions (for instance if the user is using their mobile device to access the internet) are also transmitted from the user's device to a RAN, which then transmits the data to the core network for processing. Thus, in one or more examples, RANs are instrumental in provide a mobile or wireless user with access to a core network.

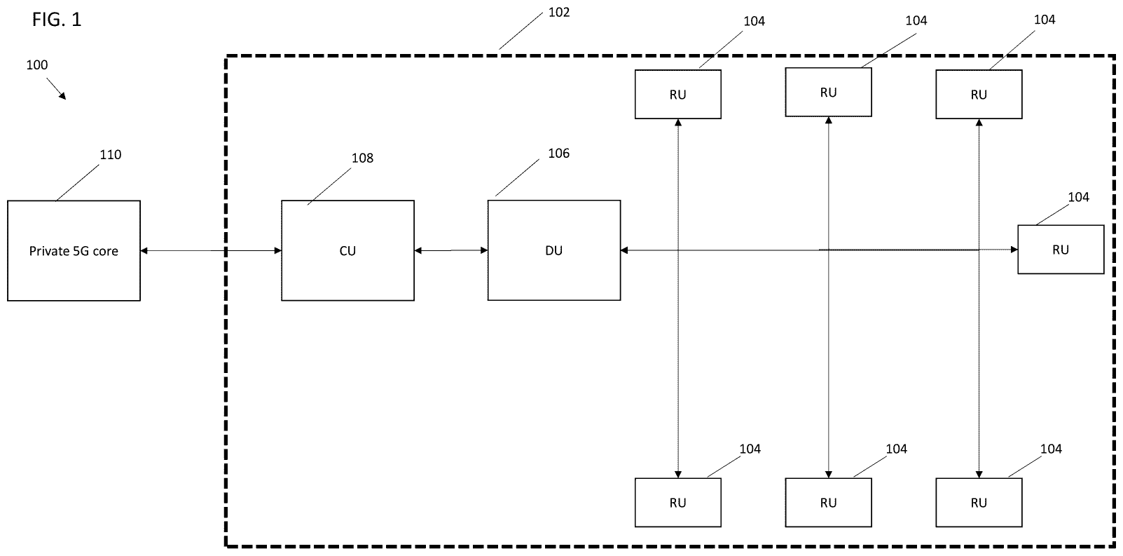

FIG. 1 illustrates an RAN architecture according to examples of the disclosure. In one or more examples, the RAN architecture 100 illustrated in FIG. 1 can be part of a 5G mobile network. In one or more examples, the RAN architecture 100 can be configured to provide one or more end users with access to a private 5G core network that may for instance be operated by a private enterprise, and thus may not be accessible by the public. In one or more examples, the architecture 100 can include a RAN 102 that can connect an end user to a private 5G core network 110. In one or more examples, the RAN 102 can include a plurality of radio units (“RU”) 104 that act as the RF interface between an end user and the RAN 102. In one or more examples, an end user can be wirelessly connected to one or more of the RUs 104 in the RAN 102 based on their physical proximity to an RU. Once wirelessly connected to an RU, the RU can be configured to receive wireless transmissions from the end user, and also send wireless transmissions to the end user that it is connected to. Thus, in one or more examples, an RU can act as the access point for a user to the RAN 102, so that ultimately the user can access the core 110 wirelessly.

In one or more examples, each RU 104 can be connected to one or more data units (“DU”) 106. In one or more examples, DU 106 can represent a logical unit that can be responsible for handling data transmission at one or more protocol layers (such as Radio Link Control (RLC), Medium Access Control (“MAC”), and/or the Physical layer. In one or more examples, the DU 106 can be configured to route messages it receives from the core network 110 (through the CU 108 discussed below) to the RUs that are connected to a particular user. In one or more examples, the DU 106 can receive traffic from the core network that has been associated (i.e., tagged) to a particular user-connection of the network, and can then route the data to the one or more RUs 104 in the network that the user is connected to. In this way, the data meant for a particular user is routed to the appropriate RUs (i.e., cells) that a user is connected with. In one or more examples the RU-DU connection can be referred to as an open RAN (“O-RAN”) fronthaul.

In one or more examples, DU 106 can be connected to one or more collector/concentrator unit (“CU”) that can be configured to implement such protocol layers as radio resource control (“RRC”), service data adaptation protocol (“SDAP”), and packet data convergence control (“PDCP”). In one or more examples, a single CU can be connected to multiple DU's and can thus route the data received from the network 110 to the appropriate DU 106 and ultimately to the appropriate RU 104 depending on the user that is the intended recipient. In one or more examples, the connection between a CU and DU can be referred to as the O-RAN midhaul. In one or more examples, CU 108 can be connected to core network 110 and thus serves as the interface between the core 110 and the RAN 102. In one or more examples, the connection between the CU 108 and the core 110 can be referred to as the O-RAN backhaul.

In one or more examples, the RUs 104 described above can utilize RF spectrum resources to distribute messages and receive messages from users. For instance, in one or more examples, a RF spectrum band can be split into one or more “physical resource blocks” (“PRB”), with each user assigned to a PRB. Thus in one or more examples, when a transmission is received by a RU for a particular user, the RU can transmit to signal to the user by transmitting the signal at the frequency of their assigned PRB. In this way, a spectrum can be efficiently divided to ensure efficient communications with minimal signal interference. However, the PRB method described above, can be further modified to increase network capacity as described below.

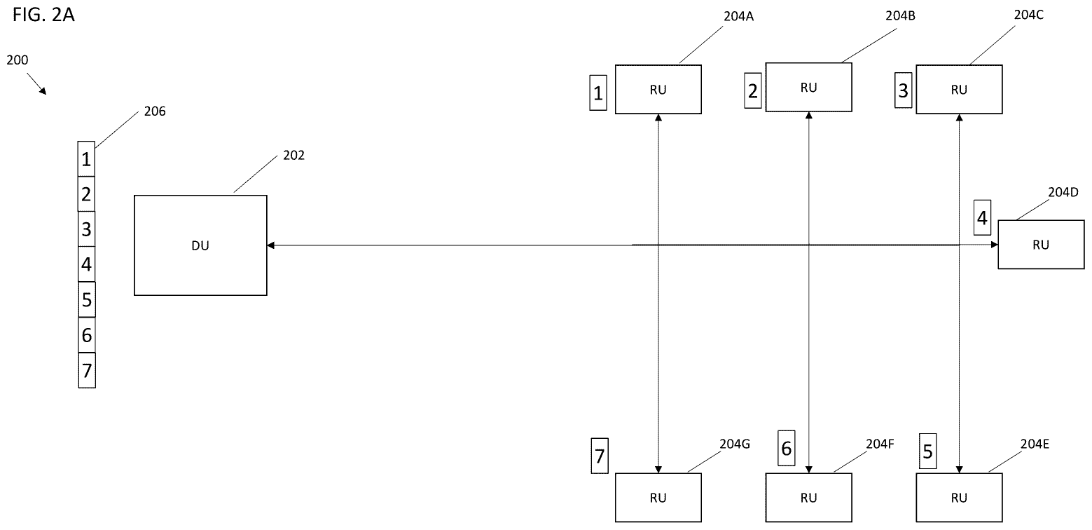

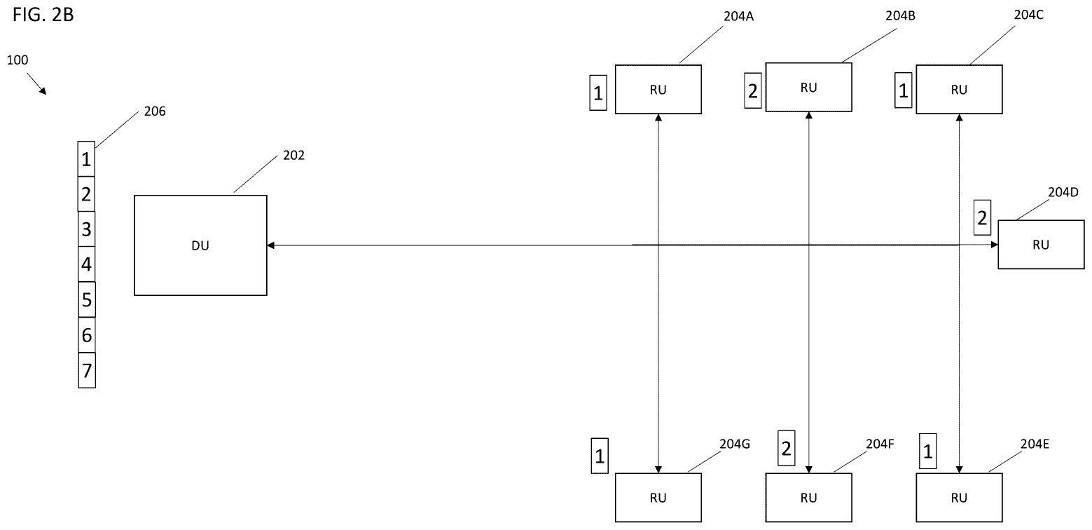

FIG. 2A illustrates an exemplary spectrum sharing system according to examples of the disclosure. In one or more examples, the system 200 of FIGS. 2A and 2B illustrate an exemplary O-RAN fronthaul system which includes a plurality of RUs 204A-204G that are each connected to a common DU 202. In one or more examples, each RU 204A-204G can represent one or more RUs that are connected to an individual user, such that RU 204A represents one or more RUs that are connected to a first user, RU 204B represents one or more RUs that are connected to a second user, RU 204C represents one or more RUs that are connected to a third user, and so on and so forth, until RU 204G which represents one or more RUs that are connected to a seventh user. In the example of front-haul system 200, only seven users are shown, however the number of users is merely meant as an example and should not be seen as limiting to the disclosure. Thus, in one or more example a system such as the system 200 can include more RUs, more users, and multiple users connected to the same RUs.

In one or more examples, and as described in detail above, the DU 202 can be configured to distribute network traffic meant for a particular user to the appropriate RU for distribution. For instance, in one or more examples, the DU 202 can receive network traffic meant for a first user, and distribute that traffic to RU 204A that is associated with the first user. Likewise, DU 202 can distribute any traffic meant for the second user to RU 204B, the third user to RU 204C and so and so forth. In one or more examples, since RUs 204A-204G may be operating in proximity to one another such that the RF signals that each RU transmits may interfere with one another. For instance, in one or more examples, if both RU 204A RU 204B were to transmit signals at the same RF frequency or band, the two signals may interfere with one another such that the first user who is associated with RU 204A and the second user associated with RU 204B may receive interference from RU 204B and RU 204A respectively. Thus, in one or more examples, the DU 202 can coordinate the frequencies and bands that each RU 204A-G transmit and receive at, so as to minimize interference between the RUs.

In one or more examples, the DU can coordinate the frequency band that each RU 204A-G transmit at any given moment in time by assigning each RU a specific frequency band to transmit at any given moment. For instance, in one or more examples, if the RUs 204A-G are able to transmit signals over a 10 MHz band, then in one or more examples, the DU 202 can split the band into physical resource blocks (“PRBs”) which each PRB representing a slice or section of the 10 MHz band. In one or more examples, a 10 MHz band can be split into 50 PRBs, with each PRB representing a 200 KHz bandwidth signal within the 10 MHz band. By splitting the band into PRBs, the DU 202 can coordinate which PRB each RU 204A-G transmits at any given time to thus ensure that the RUs don't interfere with one another for instance by having two proximal RUs transmit the same PRB at the same time.

In one or more examples, the DU 202 can assign a specific PRB to a specific user. For instance in the example 200 of FIG. 2A, DU 202 can include a spectrum 206 that has at least seven PRBs (spectrum 206 may have more PRBs than seven, but only seven are shown in FIGS. 2A-2B). In one or more examples, each PRB 1-7 of spectrum 206 may be assigned to each of the users assigned to the RUs of system 200, such that the first user associated with RU 204A is assigned PRB 1, the second user associated with RU 204B is assigned PRB 2, and so on and so forth. Thus, in one or more examples, if DU 202 receives a transmission to or from the first user, then DU 202 can instruct RU 204A to transmit or communicate with the first user using the spectrum associated with PRB 1. Likewise, for the second user, if DU 202 receives a transmit to or from the second user, the DU 202 can instruct RU 204B to transmit or communicate with the second user using the spectrum associated with PRB 2, and so on and so forth with each user and RU associated with the user.

By assigning each user their own PRB, or even by assigning each RU 204A-G its own PRB, the DU 202 can ensure that each of the RU 204A-G do not interfere with one another during operation. However, in one or more examples, the assignment of the PRBs in the manner described above may not be the most efficient allocation of network resources, and may ultimate unduly limit the number of users that can be operating within a given network at any given time. Thus, in one or more examples, and as described in further detail below, DU 202 can be configured to “reuse” PRBs, such that multiple RUs (which are not in proximity to one another) can use the same PRB at the same moment in time, thereby reusing a single PRB multiple times, thereby increasing the overall capacity of the network to deal with user traffic.

FIG. 2B illustrates another exemplary spectrum sharing system according to examples of the disclosure. The examples of FIG. 2B can include the same system 200 of FIG. 2A, with the only difference being the manner that the PRBs are allocated by the DU 204. In one or more examples, the DU 202 can allocate the PRBs of spectrum 206 based on RU proximity, such that multiple RUs can transmit the same PRB at the same time. In one or more examples, the DU 202 can assign the same PRB to the RUs based on the RUs proximity to one another, such that even though each RU is transmitting the same PRB, they will not interfere with one another since they are not close enough together to interfere with one another.

In one or more examples, at a first moment in time, DU 202 can assign PRB 1 to RUs 204A, 204C, 204E, and 204G so long as those RUs have been previously determined to not be in close enough proximity to one another so as to interfere with one another. In one or more examples, each of RU 204A, 204C, 204E, and 204G can each represent a virtual cell (that can itself include one or more RUs), with each cell using PRB 1. In one or more examples, DU 202 can assign PRB 2 to RUs 204B, 204D, and 204F so long as those RUs have been previously determined to not be in close enough proximity to one another so as to interfere with one another. In one or more examples, each of RU 204B, 204D, and 204F can each represent a virtual cell (that can itself include one or more RUs), with each cell using PRB 2. In a similar manner, PRBs 3-7 can be assigned to one or more virtual cells, based on proximity of the RUs and the specific RUs that are associated with individual users in the network. In this way, each PRB rather than being assigned to a specific user, can instead be reused multiple times at a given moment in time, thus increasing the overall capacity of the system.

The example systems of FIGS. 1 and 2A-B have been discussed with respect to a single private 5G network. However, as also described above, in some instances, access to public network operators (i.e., MNOs) may also be desired in a given facility. However, in one or more examples, and as described above, installing separate RANs for each MNO may be cost prohibitive and otherwise infeasible. Thus, in one or more examples, having the MNOs share RAN infrastructure with a private 5G network or with each other can help to reduce the overall cost of operating multiple 5G networks in the same facility, when the facility is unable to receive public MNO signals inside of the facility due to poor cell tower reception.

In one or more examples, various parts of the RAN can be shared between MNOs and private networks. For instance, in one or more examples, the RU of a private network can be shared between the public MNOs and the private network so as to provide both private and public network coverage. In one or more examples, the RUs can operate as multi-band antenna's that transmit at multiple frequencies. Thus, in one or more examples, each RU of the system can be shared creating a distributed antenna system (“DAS”) that can allow for sharing of the RUs between multiple private and public network operators. However, in one or more examples, such as system cannot realize the spectral efficiency engendered by the spectrum sharing scheme described above with respect to FIGS. 2A-2B since, the DU is not connected to all the of the operators and thus cannot coordinate the allocation of PRBs amongst the different operators. Thus, sharing the RAN at the front-haul may be feasible, but may not allow for cell virtualization, and furthermore may cause latency and bandwidth issues.

Alternatively, rather than sharing the RU, various MNOs and private networks can share Private 5G-RAN consisting of RUs, DU and CU via the backhaul system, such that the CU of a RAN is shared. However, having a common CU for all of the public and private networks to share can engender its own problems. For instance, the CU, which would be operated by one of the public or private network operators, would be required to go through any received traffic and determine which network the traffic is associated with it, much like a cellular roaming interface in which a second MNO receives a first MNO's data and then distributes it to the first MNO. Such as system could also have RRM handoff & PDCP security/encryption issues which makes RAN sharing difficult or un-acceptable. Ideally, indoor coverage by a private-RAN should integrate with a broader MNO's gNB traffic as part of common CU processing and enable a self-organizing RF-network environment with smooth and secure handoff from public-RAN to private-RAN and vice-versa.

Thus, in one or more examples, using the mid-haul section of a private 5G network may allow for efficient spectrum sharing as discussed above with respect to FIGS. 2A and 2B, while also alleviating the security issues that may arise due to back-haul sharing as discussed above. As described in further detail below, implementing a “proxy” F1 or IAB system as a DU that can receive data from multiple MNO, and coordinate the transmissions of the RU to ensure that the data gets to intended user in a spectrally efficient process can allow for RAN sharing that minimizes any security and handoff issues commonly found with RAN sharing, while also allowing for the system to take advantage of RU coordination to achieve spectral efficiency.

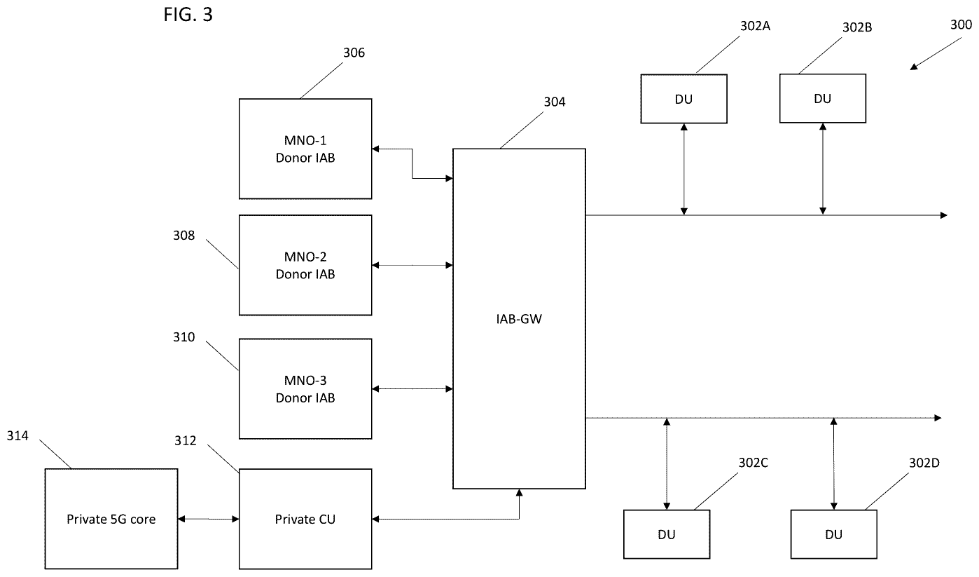

FIG. 3 illustrates an exemplary shared RAN system according to examples of the disclosure. In one or more examples, the system 300 of FIG. 3 can represent a shared RAN architecture in which three public MNOs and a private 5G-network share a private-RAN system. In one or more example, the system 300 includes a plurality of RUs 302A-D which can be connected to one or more end users who are wirelessly connected to the RUs 302A-302D and use the RUs as an access point to one or more private and/or public mobile network operators. In one or more examples, the system 300 can include one or more MNOs CUs that are for public use and are shared by many users. In one or more examples, the system 300 is shown as include three separate MNOs (MNO-1, MNO-2, and MNO-3) that can share access to a private RAN architecture with a private 5G core network. Thus, in one or more examples, the system 300 can include an MNO-1 CU 304, a MNO-2 CU 306, and an MNO-3 CU 308.

In one or more examples, the MNO-1, MNO-2, and MNO-3 CUs 304, 306, and 308 respectively can be owned and operate by the MNOs themselves and can be thus housed on an MNOs private facilities away from the facility or location of the shared private 5-G RAN 330. In one or more examples, the MNOs can connect to the private RAN 330 using either a wired or wireless connection. For instance, in one or more examples, MNO-1 Donor CU 304 can be connected to the private 5G RAN 330 using a wired F1 connection. In one or more examples, the MNO-1 CU can be connected to the private 5G RAN 330 via a F1-gateway (GW) 312. In one or more examples, since MNO-1 CU 304 is connected to many DUs across its coverage network, and since the link coming from the private RAN 330 represents an external link that is not within the control of MNO-1, in one or more examples, any transmissions sent to the MNO-1 from the private RAN 330 can be received by F1-GW 312 which can be owned and operated by MNO-1 and configured to act as a firewall for the MNO-1 Donor CU insofar as it can scrutinize received transmission to determine their authenticity and to otherwise check for malicious or suspicious transmissions.

In one or more examples, MNOs 2 and 3 can be connected to the private RAN 330 via a wireless connection. For instance in one or more examples MNO-2 CU 306 and MNO-3 CU 308 can be implemented as Donor CUs, that are located on wireless infrastructure (such as a cell tower base station) that is located away from the core network of the MNOs. In one or more examples, and similar to the F1-GW 312 described above with respect to MNO-1, MNO-2 Donor CU 306 and MNO-3 CU 308 can receive transmissions from the private RAN 330 and scrutinize those transmissions for security purposes since the received wireless traffic came from a network that is not within the MNOs control. In one or more examples, the system 300 can also include a private 5G core 310 that can be connected to the private RAN 330 using a private CU 318. In one or more examples, the private 5G core 310 and the private CU 318 can be owned and operated by the same entity that owns the private RAN 330. Thus, in one or more examples, the system 300 can allow for a private network running private communications via at private 5G core to be shared with one or more public MNOs that are owned and maintained by external entities.

In one or more examples, the private RAN 330 can include one more protection proxy DUs, (PP-DU), with a single PP-DU associated with one or more MNO operation on the private RAN 330. Thus in one or more examples, the private RAN 330 can include a F1-PP DU 320 that can be configured to transmit and receive network traffic to and from MNO-1 Donor CU. Additionally, private RAN 330 can include IAB-PP DU 322 that can be configured to transmit and receive network traffic to and from MNO-2 Donor CU 306. In one or more examples, the private RAN can also include a IAB-PP DU 324 that can be configured to transmit and receive network traffic to and from MNO-3 Donor CU 308. In one or more examples, each of the proxy DUs 320, 322, and 324 can be configured to receive network traffic intended for its associated MNO from a scheduler DU 328 (described in further detail below) and route the traffic (either via a wired or wireless connection) to its respective MNO.

In one or more examples, to facilitate RAN sharing between the MNOs and the private networks, the system 300 can include an scheduler DU 328. In one or more examples, scheduler DU 328 can be configured to receive traffic from multiple MNO CUs 304, 306, and 308 over 5G-PHY to support multiple PLMNs of MNO or Private 5G-network. In one or more examples, the scheduler DU can receive traffic from each of the MNOs 304, 306, and 308 as user's RLC-connection traffic to identify which MNO or private network the traffic came from. In one or more examples, the scheduler DU 328 can then be configured to distribute the traffic to the appropriate RUs 302A-D based upon the PLMN, Network-slice-ID and RLC-connection information that belongs to MNO 306, 308, and 310. Likewise, the scheduler DU 328 can route the data coming from private CU 310 using PLMN, Network slice-ID and RLC connection-header to identify traffic coming from the private network for one or more users in the network that is connected to the one or more RUs 302A-D. In one or more examples, the scheduler DU can distribute the traffic to the one or more RUs using PRBs that may be reserved for a specific MNO or private network (described in further detail below).

In one or more examples, the scheduler DU 328 can also be configured to receive network traffic from the RUs 302A-D, and distribute the traffic to the appropriate MNO CU 304, 306, and 308 and/or private CU 310 based on information included in the traffic. For instance, in one or more examples, a user using the first MNO associated with MNO CU 304 can have their traffic routed based on PLMN-ID, Network Slice-ID and RLC-connection-ID received in PDU by scheduler DU 328 such that the traffic is not only associated with the particular user, but is also associated (via PLMN, Network slice-ID and RLC-connection ID) to the specific MNO or private network that the user is communicating on. In one or more examples, scheduler DU 328 can receive the traffic from each of the RUs 302A-302D and distribute the traffic to the appropriate MNO proxy-F1 or proxy-IAB or private DU based on the information provided with the traffic that identifies the network that the traffic belongs to.

In one or more examples, the scheduler DU 328 can control the RUs 302A-D to transmit the data from each RU to the users using Multi-Operator Core Network (“MOCN”) and Multi Operator RAN (“MORAN”) configurations. In one or more examples, the RUs using the MORAN configuration can separate traffic for each MNO or private carriers into separate spectral bands (assuming the RUs are configured as multi-band RUs) or alternative the DUs can use the MOCN configuration wherein the traffic is placed onto the same band shared by multiple 5G-networks. As discussed above, in one or more examples, by providing shared access at the mid-haul level of a RAN, the spectrum sharing scheme discussed above with respect to FIGS. 2A-2B can be utilized. In one or more examples, and as explained in further detail below, a spectrum that is divided into a plurality of PRBs, can have those PRBs allocated based on a network basis such that each MNO and the private carrier can have a specific set of PRBs assigned to them. In one or more examples, the scheduler DU 328 can coordinate the association of PRBs to MNOs and the private network on a frame-by-frame basis, such that a PRBs are allocated to user's based on their location in the network and the MNO or private network that they are communicating with.

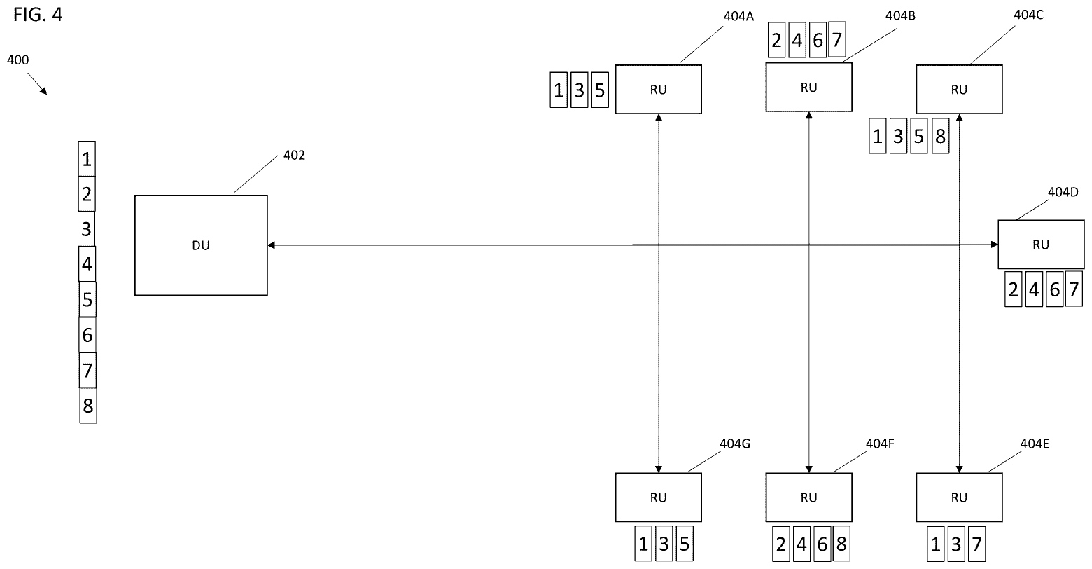

FIG. 4 illustrates an exemplary spectrum sharing system for private and public network traffic according to examples of the disclosure. In one or more examples, the system 400 can be similar to the system 200 described above with respect to FIGS. 2A-B insofar as the system includes a DU 402 (similar to the DU 202 of system 200) and a plurality of RUs 404A-D (similar to RUs 204A-H of system 200). In one or more examples, the system 400 of FIG. 4 can represent a scheduler DU 328 and the corresponding RUs 302A-D that are connected to the scheduler DU 328. Thus, in one or more examples Scheduler-DU 402 can be communicatively coupled to one or more network-specific DUs 406, 408, 410 and 412 for MAC & RLC-processing in a similar manner as described above with respect to FIG. 3.

In one or more examples, each RU 404A-G can be connected wirelessly to one or more end user devices. In one or more examples, each end user device can be associated with one of the MNOs or private carriers associated with the RAN system 400. Thus, for instance, a particular RU 404 can have multiple users connected to it, with some users utilizing a first MNO, some user utilizing a second MNO, some users utilizing a third MNO, and some users utilizing a private network (assuming that the DU 402 is a DU of the example network 300 of FIG. 3). In one or more examples, the DU 402 can receive network traffic from a IAB proxy, such as proxy 304 described above with respect to FIG. 3. In another example, and as described above, the scheduler DU can identify not only the user that a particular packet is meant for, but can also indicate the identity of the MNO or private carrier that sent the packet. Additionally, the scheduler DU 402 can receive one or more packets from the end users via the RUs 404A-D. In one or more examples, the DU 402 can identify the network that the end-user packet is associated with, and route it to appropriate Proxy or Private-DU for MAC & RLC processing and distributed to the proper MNO or private carrier core.

In one or more examples, the scheduler DU 402 can coordinate the frequency band that each RU 404A-G transmits at any given moment in time by assigning each RU a specific frequency band to transmit at any given moment. For instance, in one or more examples, if the RUs 404A-G are able to transmit signals over a 10 MHz band, then in one or more examples, the DU 402 can split the band into chunk or quota of physical resource blocks (“PRBs”) which each chuck representing a slice or section of the 10 MHz band. In one or more examples, a 10 MHz band can be split into 10 PRBS for MNO-1, 10 PRBs for MNO-2 and 30 PRBs for Private-RAN to create a total of 50 PRBs, with each PRB representing a 200 KHz bandwidth signal within the 10 MHz band.

In one or more examples, and in contrast to the example DU 202 of FIGS. 2A-B, rather than assigning PRBs to one network only, the PRBs can be allocated on an MNO/private carrier basis. For instance, in one or more examples, DU 402 can allocate the PRBs (labeled 1-8) of spectrum 406 to each MNO and private carrier sharing the RAN. For instance, in the example of system 400, DU 402 can allocate PRBs 1-2 to a first MNO, PRBs 3-4 to a second MNO, PRBs 5-6 to a third MNO, and PRBs 7-8 to a private carrier (using a RAN sharing scheme similar to that of FIG. 3). Thus, in one or more examples, similar to FIGS. 2A-B, the DU 402 can distribute packets using the PRBs allocated based on the network in a manner that minimizes or eliminates interference while reusing PRBs at any given moment in time. For instance, at a given moment in time, DU 402 can instruct each of RU 404A, 404C, 404E, and 404G to transmit data meant for the users associated with those RUs and using MNO 1, using PRB 1 (associated with MNO 1). Similarly for traffic coming from MNO 2 to users in the network, the DU 402 can distribute messages using PRB 1 for users on RU 404B, 404D, and 404F, such that PRB 1 is being reused at a single moment in time. Thus, in one or more examples, by reserving a quota of PRBs for a certain MNO or private network, the DU can effectively maximize the capacity of the network and also efficiently keep track of which MNO or carrier is associated with a user's network traffic.

Referring back to the system of FIG. 3 and as explained above, the F1-PP or IAB protection proxy (IAB-PP) can act as an interface between Private 5G-RAN and one or more public network operators who wish to access and use the Private 5G-RAN network. In one or more examples, the F1-PP or IAB-PP 322, 324, and 326 can route traffic from the shared RAN to their respective MNO 5G-core networks, and can likewise receive network traffic from the MNO-5G-Core via the MNO's F1-GW or IAB-GW to MNO's F1-PP or IAB-PP hosted on Private-Network to support DU functions for distribution to the end users via one or more RUs that are connected to the DU. In one or more examples, the MNO's F1-gateway or IAB gateway 312, 314, and 316 of FIG. 3 can ensure that the data passed through it is secured to pass through use Private-RAN network of DUs and RUs downstream in the system to not only transmit the data to the intended user, but also transfer the data in a spectrally efficient manner that allows for reuse of PRBs without causing interference thereby degrading performance of the system.

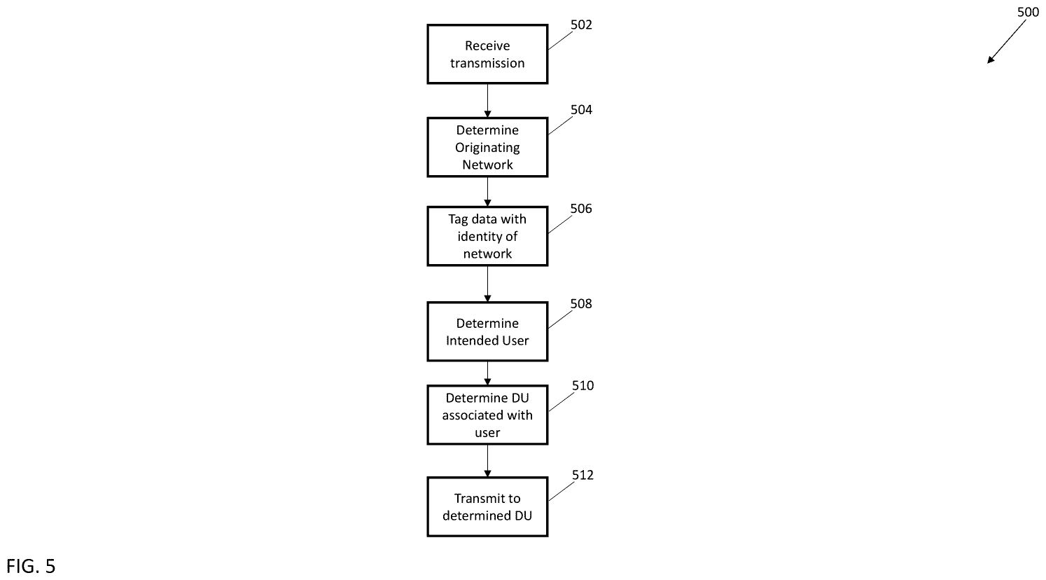

FIG. 5 illustrates an exemplary process for routing network traffic from a public network to one or more end users according to examples of the disclosure. In one or more examples, the process 500 of FIG. 5 can be performed by a scheduler DU and one more proxy DUs associated with an MNO and/or private network. In one or more examples, the process 500 of FIG. 5 can begin at step 502, wherein the one or more donor DU's (such as F1-PP DU 320, or IAB-PP DUs 410 and 412) receives a data transmission from a core network of a network operator (public or private). In one or more examples, and as described above with respect to FIG. 3, the scheduler DU and proxy DUs where the process 500 is performed on can be connected to one or more MNO CUs (i.e., a pubic carrier) and can also be connected to a private CU. In one or more examples, data received at step 502 can be received wirelessly or through a wired connection from a Donor CU associated with an MNO or a CU from a private network. In one or more examples, the MNOs (i.e., public networks) can be connected to proxy MNO DUs of the private RAN via a wireless connection, while the private network can be connected to the scheduler DU via a wired connection. However, the above examples should not be seen as limiting, and any connection to the networks could be implement either wirelessly or through a wired connection.

In one or more examples, once the data has been received at step 502 by the one or more proxy MNO DUs, the process 500 can move to step 504, wherein the donor DU processes the received information using a protocol associated with the network. For instance, in the example of 5G, the donor DU can perform layer-2 MAC and RLC processing of user-packets from a specific-network for privacy and security reasons before sending it via DU-Scheduler and 5G-PHY link to the individual users. In one or more examples, once the donor DU has processed the received data, the donor DU can transmit the processed data to the scheduler DU for further processing as described below. Once the scheduler DU has received the data from the one or more MNO Donor DUs or private DU, the in one or more examples, the process 500 can move to step 506, wherein the scheduler DU performs further processing in preparation for sending the data on to the one or more RUs of the system so that the data can be transmitted to the intended end user recipient. In one or more examples, the processing performed at step 506 can include processing that may not implicate data that is sensitive to each MNO. In one or more examples, the processing performed at step 506, can be based on user location. In one or more examples, the Scheduler DU can include one or more packet-queues or slices that are configured to receive data from one of the multiple network cores that are connected to the Scheduler DU. In one or more examples, the MNO or private CU where the data originated from can be determined based on which donor DU the data originated from. In one or more examples, the processing performed at step 506 can include queuing the data received at step 504 in a packet-queue or slice (i.e,. PRB) associated with originating network. As described above, the DUs and ultimately the RUs can use the identity of the originating network to schedule packet using PRBs for a specific network.

In one or more examples, once the data has been processed at step 506 by the scheduler DU, the process 500 can move to step 508, wherein the scheduler DU can identify the RUs associated with the user (or dedicated MAC/RLC connection-ID of a specific slice-ID) to assign a specific set of RUs for packet and number of PRBs to be used to deliver the packet. As described above with respect to FIG. 3, the Scheduler DU can be connected to multiple RUs, with each RU connected to one or more end users. Thus, in one or more examples, by identifying the intended recipient, and as explained below, the scheduler DU can schedule the received data to the RU that is associated with the intended recipient.

In one or more examples, once the intended recipient is determined at step 508, the process 500 can move to step 510 wherein the PHY-Processing is performed to pack packet-based user-data into a PHY-frame with assigned PRBs and process PRBs and create PHY-frame for each RUs. In one or more example, once the PHY-frame has been created for each RU transmission, the process 500 can move to step 512 wherein the data is transmitted to the determined RUs.

In one or more examples, and as described above, the scheduler DU (such as the scheduler DU 328 described above with respect to FIG. 3) can also be configured to route traffic from an end user to the one or more network cores that are connected to it and that are sharing the RAN. Thus, in one or more examples, and as described in further detail below, the Scheduler DU can parse traffic received from a user and use information embedded in the data to determine which MNO or private network to route the data to in order to ensure that the appropriate network receives the data that was intended for the network.

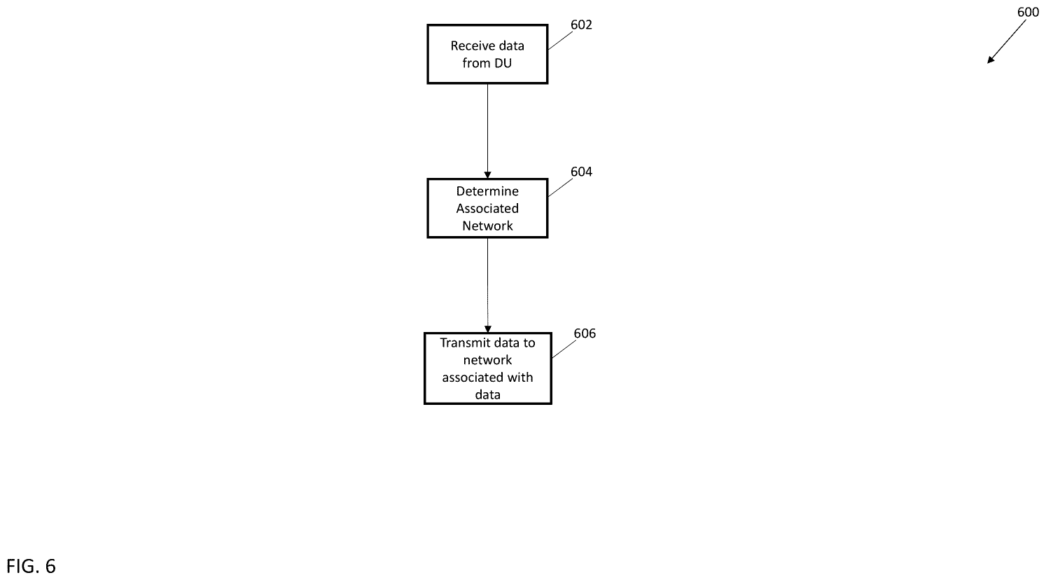

FIG. 6 illustrates an exemplary process for routing network traffic from one or more end users to one or more public and/or private networks according to examples of the disclosure. In one or more examples, the process 600 of FIG. 6 can be performed at n scheduler DU such as the scheduler DU 328 described above with respect to FIG. 3. Similar to the example of FIG. 3, the scheduler DU used to perform the process 600 of FIG. 6 can be connected to a system similar to the system 300 of FIG. 3 insofar as the scheduler DU can be connected to one or more MNO PP DU slices, and/or one or more private network cores in a manner similar to the example system 300 of FIG. 3.

In one or more examples, the process 600 of FIG. 6 can begin at step 602 wherein the scheduler DU receives data from an RU that is intended for an MNO or private network. In one or more examples, the RF signal can be received by an RU (from an end user) and processed to create a digitized frame which can be processed for lower-PHY processing and sent to the scheduler DU (at step 602). In one or more examples, once the scheduler DU has received the data from the RU, the scheduler DU (at step 602) can process the IQ stream from the RU for lower-PHY processing.

In one or more examples, once the scheduler DU has received the data from the RU at step 602, the process 600 can move to step 604 wherein RU-frames received from different RUs can be combined to create a combined frame and then decoded as part of upper-PHY processing. Once the scheduler DU has preformed the upper-PHY layer process at step 604, the process 600 can move to step 606, wherein the decode frame from upper-PHY can be divided into MAC-packets and the scheduler DU can then perform low MAC processing including any HARQ processing that is needed and is time-sensitive. In one or more examples, the process of dividing into MAC-packets can include determining which MNO or private network at particular data packet is associated with. In one or more examples, if MAC packet CRC check is verified, the packet can then be delivered to its respective MNO/private DU processing queue or slice for transmittal to the donor DU of the MNO or private network.

In one or more examples, once the scheduling DU has been transmitted to the respective donor DU of the MNO or DU of the private network at step 606, the process 600 can move to step 608, wherein the DU or Donor DU can perform MAC-processing as part of dedicated MNO/Private DU processing. Once MAC-processing has been performed, the process 600 can move to step 610, wherein RLC processing is done as part of dedicated (per PLMN) D processing. Finally, in one or more examples, once the RLC processing has been performed at step 610, the process 600 can move to step 612, wherein the data is shipped via proxy link to the MNO-CU for MNO slices or packet is shipped to Private-Cu for Private Network traffic slice.

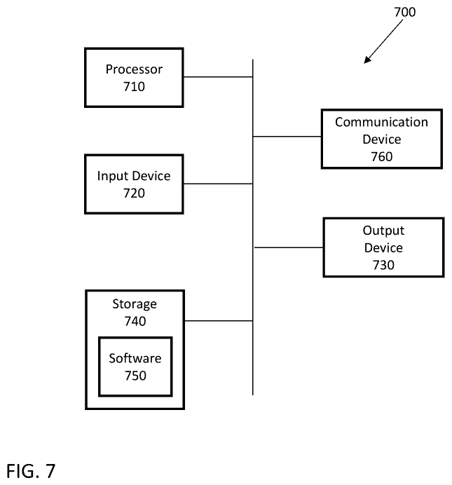

FIG. 7 illustrates an example of a computing system 700, in accordance with some examples of the disclosure. System 700 can be a client or a server. As shown in FIG. 7, system 700 can be any suitable type of processor-based system, such as a personal computer, workstation, server, handheld computing device (portable electronic device) such as a phone or tablet, or dedicated device. The system 700 can include, for example, one or more of input device 720, output device 730, one or more processors 710, storage 740, and communication device 760. Input device 720 and output device 730 can generally correspond to those described above and can either be connectable or integrated with the computer.

Input device 720 can be any suitable device that provides input, such as a touch screen, keyboard or keypad, mouse, gesture recognition component of a virtual/augmented reality system, or voice-recognition device. Output device 730 can be or include any suitable device that provides output, such as a display, touch screen, haptics device, virtual/augmented reality display, or speaker.

Storage 740 can be any suitable device that provides storage, such as an electrical, magnetic, or optical memory including a RAM, cache, hard drive, removable storage disk, or other non-transitory computer readable medium. Communication device 760 can include any suitable device capable of transmitting and receiving signals over a network, such as a network interface chip or device. The components of the computing system 700 can be connected in any suitable manner, such as via a physical bus or wirelessly.

Processor(s) 710 can be any suitable processor or combination of processors, including any of, or any combination of, a central processing unit (CPU), field programmable gate array (FPGA), and application-specific integrated circuit (ASIC). Software 750, which can be stored in storage 740 and executed by one or more processors 710, can include, for example, the programming that embodies the functionality or portions of the functionality of the present disclosure (e.g., as embodied in the devices as described above)

Software 750 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 740, that can contain or store programming for use by or in connection with an instruction execution system, apparatus, or device.

Software 750 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport computer readable medium can include, but is not limited to, an electronic, magnetic, optical, electromagnetic, or infrared wired or wireless propagation medium.

System 700 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 700 can implement any operating system suitable for operating on the network. Software 750 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated. For the purpose of clarity and a concise description, features are described herein as part of the same or separate embodiments; however, it will be appreciated that the scope of the disclosure includes embodiments having combinations of all or some of the features described.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A Radio Access Network (RAN) system configured to provided shared access to a plurality of mobile network operators (MNOs), the system comprising:
one or more donor distributed units, wherein each donor distributed unit is associated with its own mobile network operator, wherein each donor distributed unit is configured to transmit data to and receive data from a centralized unit of the mobile network operator associated with the distributed unit;
one or more radio units configured to communicate with one or more end user computing devices; and
a scheduler distributed unit, wherein the scheduler distributed is communicatively coupled to each of the one or more donor distributed units, wherein the scheduler distributed unit is configured to receive traffic from one or more donor distributed units and transmit the data to the one or more radio units for transmission to the one or more end user computing devices, and wherein the scheduler distributed unit is configured to receive data from the one or more radio units and transmit the received data to a donor distributed unit of the one or more distributed unites based on a MNO associated with the data received from the one or more radio units.

2. The RAN of claim 1, wherein the scheduler distributed unit is configured to control a frequency band at which the one or more radio units are configured to wirelessly communicate with the one or more end user devices; and wherein the distributed units control the frequency band at which the one or more radio units are configured to control the frequency band by transmitting one or more physical resource blocks of a plurality of physical resource blocks to the radio units.

3. The RAN of claim 2, wherein the scheduler distributed unit selects the physical resource block to the send to the radio units based on a determined identity of the MNO associated with the donor DU from which data is received from.

4. The RAN of claim 1, wherein the donor distributed units are configured to handle data transmissions at the Medium Access Control (MAC) layer of a 5G wireless protocol.

5. The RAN of claim 1, wherein the scheduler distributed unit is configured to:
receive a plurality data transmissions from the one or more distributed units,
determine the identity of the mobile network operator associated with each received data transmission of the plurality of data transmissions;
determine an intended recipient end user device for each received data transmission of the plurality of received data transmissions, wherein determining an intended recipient end user device for each received data transmission is based on the received data transmission;
determine which radio units of the one or more radio units are associated with the intended recipient end user device; and
transmit the data to the determined radio unit.

6. The RAN of claim 5, wherein transmit the data to the determined radio unit comprises assigning or more physical resource blocks of a plurality of physical resource blocks to the radio units based on the MNO associated with the received traffic.

7. The RAN of claim 5, wherein the scheduler distributed unit is configured to perform High-PHY layer processing.

8. The RAN of claim 1, wherein the scheduler distributed unit is configured to:
receive data from the one or more radio units;
determine an MNO associated with the received data; and
transmit the received data to the donor distributed unit associated with the determined MNO associated with the received data.

9. The RAN of claim 8, wherein the scheduler DU is configured to perform upper-PHY layer processing on the received data.

10. The RAN of claim 8, wherein the scheduler DU is configured to combine the received data from the one or more radio units into a PHY layer frame.

11. The RAN of claim 10, wherein the scheduler DU is configured to perform low MAC processing on the PHY frame.

12. The RAN of claim 10, wherein the distributed unit associated with the determined MNO is configured to perform high medium access control (MAC) processing.

13. The RAN of claim 12, wherein the distributed unit associated with the determined MNO is configured to perform radio link control (RLC) processing.

14. The RAN of claim 1, wherein the one or more donor distributed units are implemented as Integrated Access Backhaul Protection Proxy (IAB-PP) distributed units.

15. The RAN of claim 14, wherein the IAB-PP distributed unit is communicatively coupled to a donor centralized unit associated with its MNO using a wireless connection.

16. The RAN of claim 15, wherein the IAB-PP is configured to wirelessly communicate with an IAB gateway device that is connected to the donor centralized unit associated with its MNO.

17. The RAN of claim 16, wherein the IAB gateway device is configured to determine whether the data from the IAB-PP is safe for transmission to the donor centralized unit.

18. The RAN of claim 1, wherein the one or more donor distributed units are implemented as F1 Protection Proxy (FI-PP) distributed units.

19. The RAN of claim 18, wherein the F1-PP distributed unit is communicatively coupled to a donor centralized unit associated with its MNO using a wired connection.

20. The RAN of claim 19, wherein the F1-PP is configured to communicate with a F1 gateway device that is connected to the donor centralized unit associated with its MNO.

21. The RAN of claim 20, wherein the F1 gateway device is configured to determine whether the data from the F1-PP is safe for transmission to the donor centralized unit.
